(19) United States
(12) Patent Application Publication
(10) Pub. No.: US 2018/0345727 A1
(43) Pub. Date: Dec. 6, 2018

(54) HIGH TRACTION MOTORCYCLE TIRE

(71) Applicant: Heath Braun, Dickinson, ND (US)

(72) Inventor: Heath Braun, Dickinson, ND (US)

(21) Appl. No.: 15/607,700

(22) Filed: May 30, 2017

(51) Int. Cl. B60C 11/01

(52) U.S. Cl. CPC B60C 11/01; B60C 2200/10

(57) ABSTRACT

A high traction motorcycle tire that provides more traction and greater stability than a traditional motorcycle tire. The high traction motorcycle tire includes a motorcycle tire tread having a pair of outer edges, the motorcycle tire tread is adapted to make direct contact with an exterior road surface while the high traction motorcycle tire is riding and an exterior raised rim is disposed on each of the pair of outer edges of the motorcycle tire tread, the exterior raised rim having a lower edge. The lower edge of the exterior raised rim extends outward at the range of 91 to 94 degrees to provide more contact with the exterior road surface than a traditional motorcycle tire while adapted to make a partial turn or a full turn.

### BACKGROUND OF THE INVENTION

### Field of the Invention:

The present invention is a motorcycle tire. More specifically, the present invention is a high traction motorcycle tire.

### Description of the Related Art:

Motorcyclists are prone to many dangers on the road such as falling off when making tight turns and/or extreme wearing of tires when the tire sides connect with the road. Presently, there are limited amounts of products available on the market which are capable of allowing bikers to keep traction while making turns without rapid wear and tear.

What is needed is a high traction motorcycle tire that provides more traction and greater stability than a traditional motorcycle tire.

### SUMMARY OF THE INVENTION

The present invention is a motorcycle tire. More specifically, the present invention is a high traction motorcycle tire.

The high traction motorcycle tire includes a motorcycle tire tread having a pair of outer edges, the motorcycle tire tread is adapted to make direct contact with an exterior road surface while the high traction motorcycle tire is riding and an exterior raised rim is disposed on each of the pair of outer edges of the motorcycle tire tread, the exterior raised rim having a lower edge.

It is an object of the present invention to provide a high traction motorcycle tire that includes an exterior rim on each outer edge of a tread of the motorcycle tire that provides more traction and greater stability than a traditional motorcycle tire.

It is an object of the present invention to provide a high traction motorcycle tire that provides more traction on high speed turns.

It is an object of the present invention to provide a high traction motorcycle tire that is manufactured with durable materials for optimal utilization on paved roads.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a high traction motorcycle tire, in accordance with one embodiment of the present invention.

FIG. 2 illustrates a front view of a high traction motorcycle tire, in accordance with one embodiment of the present invention.

FIG. 3 illustrates a front view of a high traction motorcycle tire making a partial turn, in accordance with one embodiment of the present invention.

FIG. 4 illustrates a front view of a high traction motorcycle tire making a full turn, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

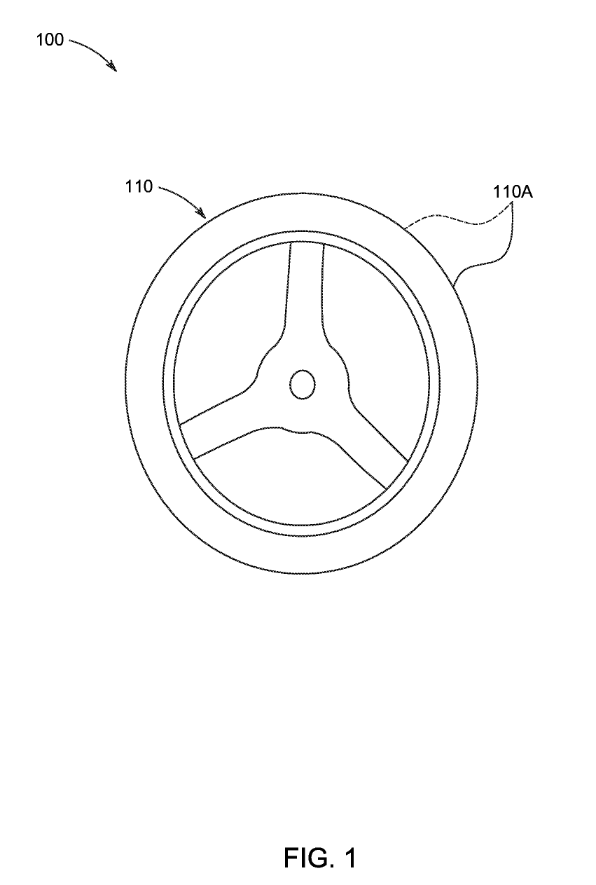

FIG. 1 illustrates a side view of a high traction motorcycle tire 100, in accordance with one embodiment of the present invention.

The high traction motorcycle tire 100 may include a motorcycle tire tread 110.

The motorcycle tire tread 110 may include a pair of outer edges 110A.

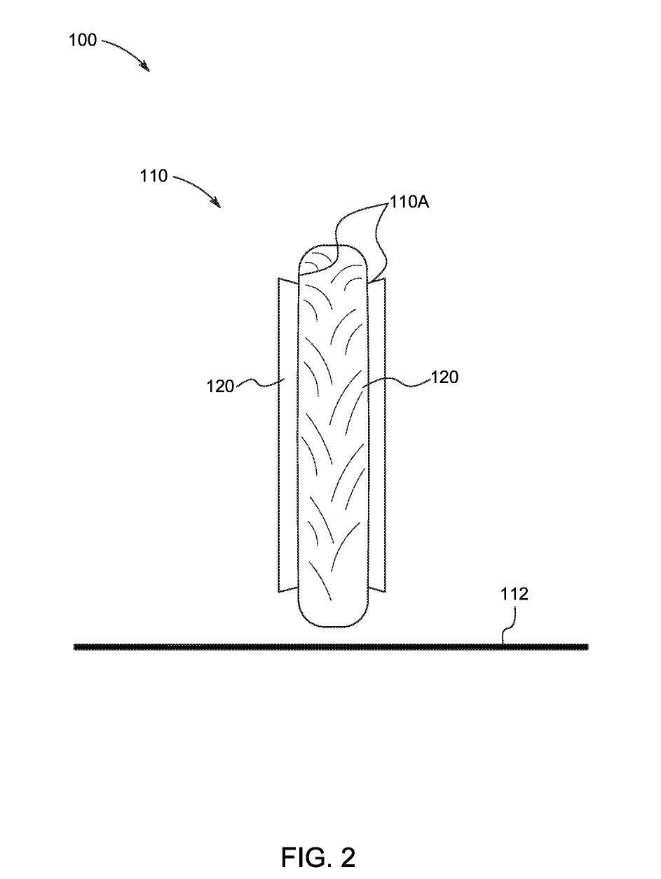

FIG. 2 illustrates a front view of a high traction motorcycle tire 100, in accordance with one embodiment of the present invention.

The high traction motorcycle tire 100 may include the motorcycle tire tread 110 and an exterior raised rim 120.

The motorcycle tire tread 110 may be adapted to make contact with an exterior road surface 112 while the high traction motorcycle tire 100 is being rode. The exterior road surface 112 is typically made of asphalt but may be made of other materials such as dirt, gravel or other suitable exterior road surface material. The exterior raised rim 120 may be disposed on each of the pair of outer edges 110A of the motorcycle tire tread 110. The exterior raised rim 120 may be made of tire-grade rubber or other suitable material for durability.

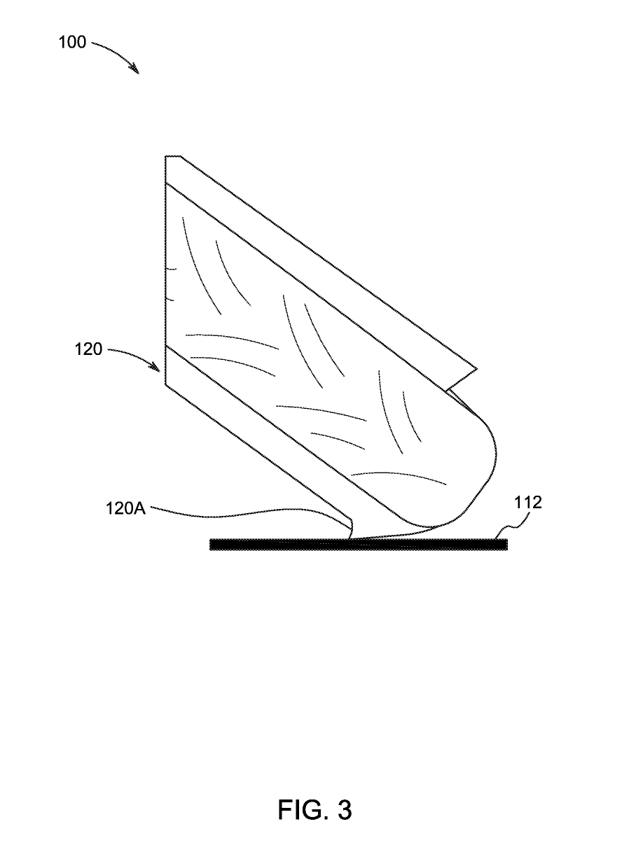

FIG. 3 illustrates a front view of a high traction motorcycle tire 100 making a partial turn, in accordance with one embodiment of the present invention.

The exterior raised rim 120 may have a lower edge 120A.

The lower edge 120A of the exterior raised rim 120 may extend outward at approximately slightly over 90 degrees to provide more contact with the exterior road surface 112 than a traditional motorcycle tire. More specifically, the lower edge 120A of the exterior raised rim 120 may extend outward at approximately the range of 91 to 94 degrees to provide more contact with the exterior road surface 112 than a traditional motorcycle tire. The lower edge 120A of the exterior raised rim 120 of the high traction motorcycle tire 100 may be adapted to make contact with the exterior road surface 112 as a motorcycle rider leans sideways while making a partial turn and providing more traction to the high traction motorcycle tire 100. This is particularly true while the high traction motorcycle tire 100 is adapted to taking high speed turns that are often encountered by motorcycle track racers or while driving on curvy roads.

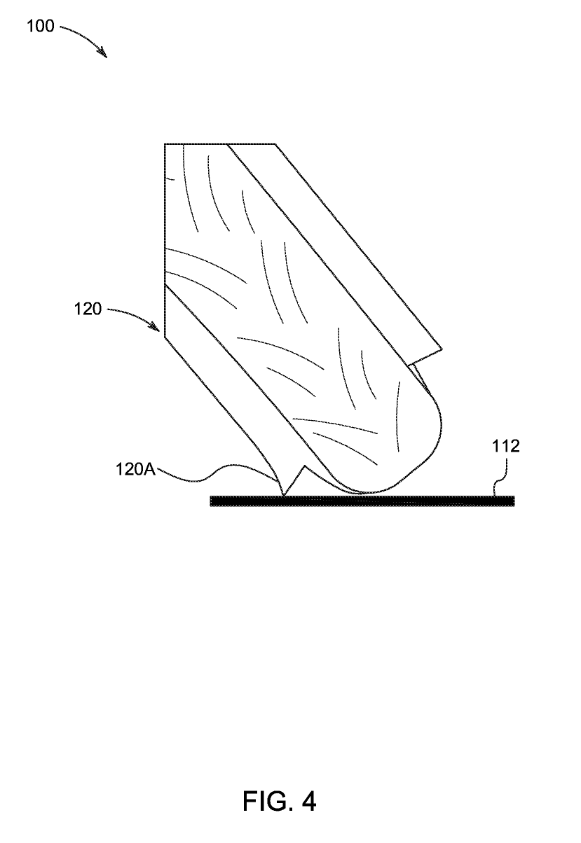

FIG. 4 illustrates a front view of a high traction motorcycle tire 100 making a full turn, in accordance with one embodiment of the present invention.

The lower edge 120A of the exterior raised rim 120 of the high traction motorcycle tire 100 may be adapted to make contact with the exterior road surface 112 as a motorcycle rider leans sideways while making a full turn and providing more traction to the high traction motorcycle tire 100. The contact with the exterior road surface 112 as a motorcycle rider leans sideways while making a full turn is less than the contact made with the exterior road surface 112 as a motorcycle rider leans sideways while making a partial turn and providing more traction to the high traction motorcycle tire 100.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A high traction motorcycle tire, comprising:
a motorcycle tire tread having a pair of outer edges, the motorcycle tire tread is adapted to make direct contact with an exterior road surface while the high traction motorcycle tire is riding; and
an exterior raised rim disposed on each of the pair of outer edges of the motorcycle tire tread, the exterior raised rim has a lower edge.

2. The high traction motorcycle tire according to claim 1, wherein the exterior road surface is made of material is selected from the group consisting of asphalt, dirt or gravel.

3. The high traction motorcycle tire according to claim 1, wherein the exterior raised rim is made of tire-grade rubber for durability.

4. The high traction motorcycle tire according to claim 1, wherein the lower edge of the exterior raised rim extends outward at the range of 91 to 94 degrees to provide more contact with the exterior road surface than a traditional motorcycle tire while adapted to make a partial turn.

5. The high traction motorcycle tire according to claim 1, wherein the lower edge of the exterior raised rim extends outward at the range of 91 to 94 degrees to provide more contact with the exterior road surface than a traditional motorcycle tire while adapted to make a full turn.

6. The high traction motorcycle tire according to claim 5, wherein contact with the exterior road surface as a motorcycle rider leans sideways while making the full turn is less than the contact made with the exterior road surface as the motorcycle rider leans sideways while making the partial turn and providing more traction to the high traction motorcycle tire.
